(19) United States
(12) Patent Application Publication
(10) Pub. No.: US 2008/0001591 A1
(43) Pub. Date: Jan. 3, 2008

(54) Voltage regulator providing power from AC power source

(76) Inventor: Ta-Yung Yang, Milpitas, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/477,494

(22) Filed: Jun. 30, 2006

(51) Int. Cl. G05F 5/00

(52) U.S. Cl. 323/299

(57) ABSTRACT

The present invention provides a high efficiency voltage regulator for generating a regulated output voltage from an AC power source. It includes a switch coupled to a voltage source from the AC power source to provide a supply voltage. An input detection circuit is coupled to the voltage source to turn off the switch when the voltage level of the voltage source is higher than a threshold voltage. An output detection circuit is connected to the supply voltage to turn off the switch once the voltage level of the supply voltage is higher than an output-over-voltage threshold. The switch can only be turned on when the voltage level of the voltage source is lower than the threshold voltage and the voltage level of the supply voltage is lower than a hysteresis threshold.

### BACKGROUND OF THE INVENTION

1. Field of the Invention

The present invention relates to a power converter. More particularly, the present invention relates to a voltage regulator.

2. Description of Related Art

FIG. 1 shows a traditional voltage regulator for supplying a regulated voltage V_{Z} from a line voltage V_{AC}. A rectifier circuit 10 including a plurality of rectifiers is coupled to the line voltage V_{AC} and provides the rectification to generate an input voltage V_{IN}. A capacitor 11 is connected from the input voltage V_{IN} to a capacitor 15 to produce the regulated voltage V_{Z}. A zener diode 16 is connected to the capacitor 15 for the regulation. A resistor 12 is used for the discharge of the capacitor 11. This traditional voltage regulator has been widely used in home appliances, such as coffee maker, cooling fan and remote controller, etc. However, the drawback of this traditional voltage regulator is high power consumption, particularly for light load and no load situations. Both the resistor 12 and the zener diode 16 cause significant power losses. Therefore, reducing the power loss is required. The object of present invention is to provide a high efficiency voltage regulator for generating a regulated voltage from an AC power source.

### SUMMARY OF THE INVENTION

The present invention provides a voltage regulator includes a switch coupled to receive a voltage source for producing a supply voltage at the output terminal of the voltage regulator. An input detection circuit is coupled to the voltage source to generate a control signal in response to the voltage level of the voltage source. The control signal is utilized to turn off the switch when the voltage level of the voltage source is higher than a threshold voltage. An output detection circuit is coupled to the supply voltage to generate a first enable signal and a second enable signal in response to the voltage level of the supply voltage. The first enable signal is coupled to switch off the switch once the voltage level of the supply voltage is higher than an output-over-voltage threshold. The switch can only be turned on when the voltage level of the voltage source is lower than the threshold voltage and the voltage level of the supply voltage is lower than a hysteresis threshold. The second enable signal is utilized to disable a regulator when the supply voltage is lower than an output-under-voltage threshold. The regulator is coupled to the supply voltage to generate a regulated output voltage.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings.

FIG. 1 shows a circuit diagram of a traditional voltage regulator.

FIG. 2 shows a circuit diagram of a preferred embodiment of a voltage regulator according to the present invention.

FIG. 3 shows a circuit diagram of a preferred embodiment of a supply circuit of the voltage regulator according to the present invention.

FIG. 4 shows a circuit diagram of a preferred embodiment of an output detection circuit of the supply circuit according to the present invention.

FIG. 5 shows a circuit diagram of another preferred embodiment of the voltage regulator according to the present invention.

FIG. 6 shows the input voltage waveform of the voltage regulator shown in FIG. 5 according to the present invention.

FIG. 7 shows a circuit diagram of a preferred embodiment of the supply circuit of the voltage regulator shown in FIG. 5 according to the present invention.

FIG. 8 shows a circuit diagram of a preferred embodiment of the output detection circuit of the supply circuit shown in FIG. 7 according to the present invention.

FIG. 9 shows a circuit diagram of a preferred embodiment of a regulator of the supply circuit according to the present invention.

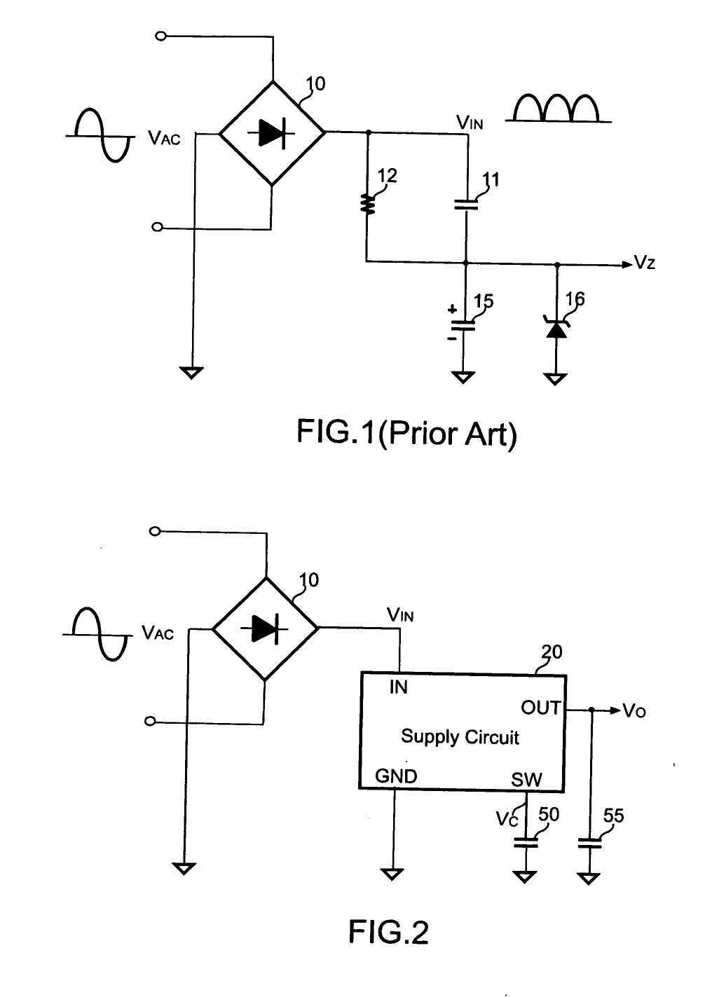

### DETAILED DESCRIPTION OF THE INVENTION

FIG. 2 shows a circuit diagram of a preferred embodiment of a voltage regulator according to the present invention. The rectifier circuit 10 includes a plurality of rectifiers. The rectifier circuit 10 is coupled to receive the line voltage V_{AC} to produce the input voltage V_{IN} coupled to an input terminal IN of a supply circuit 20. The line voltage V_{AC} is an AC power source. The input voltage V_{IN} is a voltage source and is rectified by the rectifier circuit 10. The supply circuit 20 generates a supply voltage V_{C} at a first output terminal SW. Furthermore, the supply circuit 20 will generate a regulated output voltage V_{O} at the second output terminal OUT. A ground terminal GND of the supply circuit 20 is coupled to the ground. A capacitor 50 is connected to the first output terminal SW for holding energy. Furthermore a capacitor 55 is connected to the second output terminal OUT. The voltage regulator is also called a voltage regulation circuit or a power supply circuit.

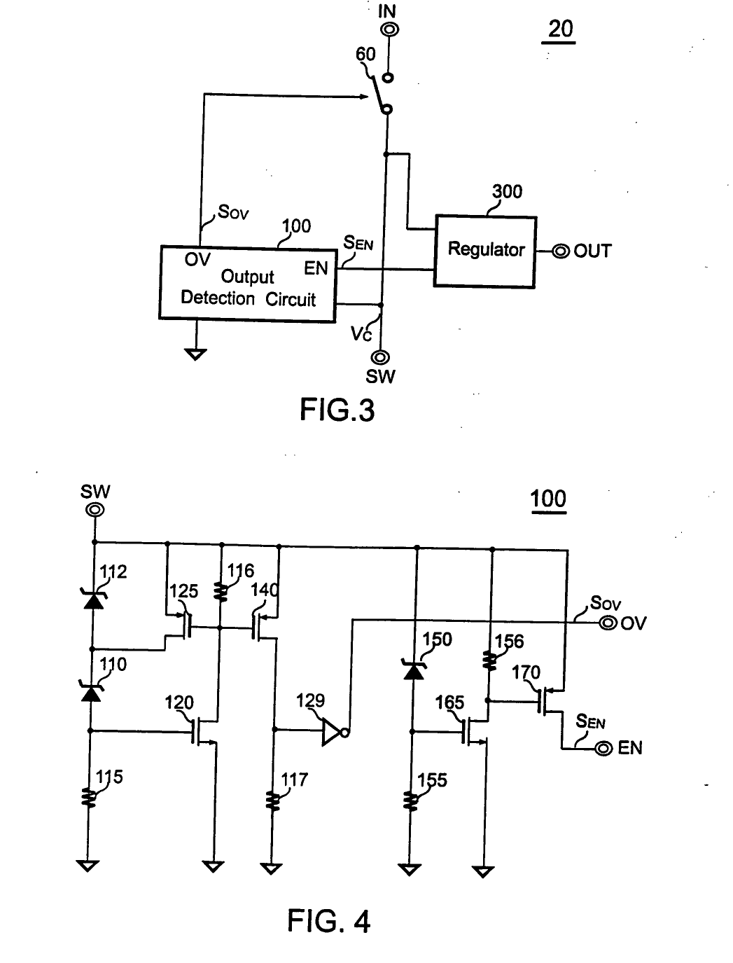

FIG. 3 is a circuit diagram of a preferred embodiment of the supply circuit 20 of the voltage regulator. The supply circuit 20 comprises a switch 60 coupled to the input terminal IN to receive the input voltage V_{IN} for providing the supply voltage V_{C} at the first output terminal SW. An output detection circuit 100 is coupled to the first output terminal SW to detect the supply voltage V_{C} for generating a first enable signal S_{OV} at a first enable terminal OV of the output detection circuit 100 in response to the voltage level of the supply voltage V_{C}. The first enable signal S_{OV} is coupled to switch off the switch 60 when the voltage level of the supply voltage V_{C} is higher than an output-over-voltage threshold. Besides, the output detection circuit 100 generates a second enable signal S_{EN} at a second enable terminal EN of the output detection circuit 100 in response to the voltage level of the supply voltage V_{C}. The second enable signal S_{EN} is connected to a regulator 300 to turn off the regulator 300 when the voltage level of the supply voltage V_{C} is lower than an output-under-voltage threshold. The regulator 300 is coupled to the supply voltage V_{C} at the first output terminal SW to generate the regulated output voltage V_{O}. The regulated output voltage V_{O} is coupled to the second output terminal OUT.

FIG. 4 shows a circuit diagram of a preferred embodiment of the output detection circuit 100. Zener diodes 110 and 112 are connected in serial. The zener diode 112 is further connected to the first output terminal SW to detect the supply voltage V_{C}. The zener diode 110 is connected to a resistor 115. The resistor 115 is further coupled to a transistor 120. The resistor 115 is used to turn on the transistor 120 when the voltage level of the supply voltage V_{C} is higher than the voltage of zener diodes 110 and 112. A transistor 125 is parallel connected with the zener diode 112 to short circuit the zener diode 112 when the transistor 120 is turned on, which achieve a hysteresis for detecting the over voltage of the supply voltage V_{C}. The zener voltage of the zener diodes 110 and 112 determines the output-over-voltage threshold. The zener voltage of the zener diode 112 determines a hysteresis threshold for the hysteresis. The first enable signal S_{OV} will switch on the switch 60 when the voltage level of the supply voltage V_{C} is lower than the hysteresis threshold.

A transistor 140 is coupled to the transistor 120 and the first output terminal SW. The transistor 140 is turned on in response to the turn-on of the transistor 120. A resistor 116 is coupled to the first output terminal SW, the transistors 125 and 140. The resistor 116 provides a bias to transistors 125 and 140. A resistor 117 is connected to the transistor 140 and an inverter 129 to control the inverter 129 when the transistor 120 is turned on. The inverter 129 is coupled to the transistor 140. The inverter 129 is further connected to the switch 60 and generates the first enable signal S_{OV} to turn off the switch 60 once the voltage level of the supply voltage V_{C} is higher than the output-over-voltage threshold.

A zener diode 150 is also connected to the first output terminal SW to detect the supply voltage V_{C}. A resistor 155 is connected to the zener diode 150 and a transistor 165 to turn on the transistor 165 once the voltage level of the supply voltage V_{C} is higher than the output-under-voltage threshold. The zener voltage of the zener diode 150 determines the output-under-voltage threshold. A resistor 156 is coupled to the first output terminal SW and a transistor 170. The transistor 170 is further coupled to the first output terminal SW and the transistor 165. The transistor 170 generates the second enable signal S_{EN} when the voltage level of the supply voltage V_{C} is lower than the output-under-voltage threshold. The voltage level of the output-over-voltage threshold is higher than the hysteresis threshold. The voltage level of the hysteresis threshold is higher than the output-under-voltage threshold.

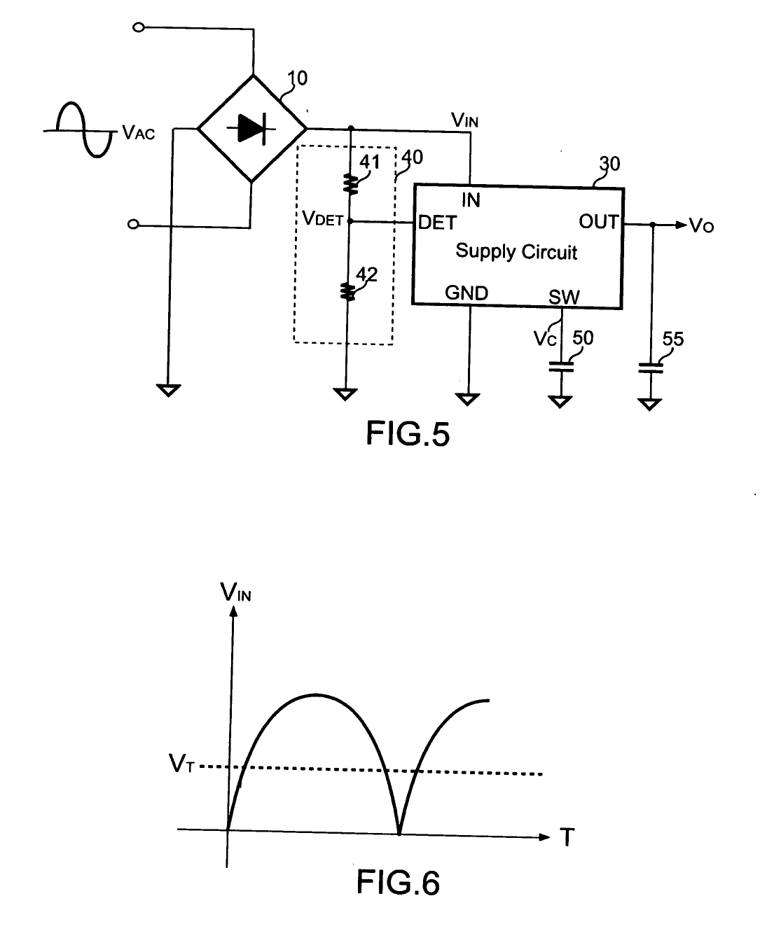

FIG. 5 shows a circuit diagram of another preferred embodiment of the voltage regulator, in which the control of a supply circuit 30 is synchronized with the line voltage V_{AC}. The input of the supply circuit 30 can only be turned on when the input voltage V_{IN} is lower than an input threshold voltage, which reduces the switching loss of the switch 60 and improves the efficiency of the voltage regulator. FIG. 6 shows the waveform of the input voltage V_{IN}, in which the input voltage V_{IN} is delivered to the first output terminal SW when the input voltage V_{IN} is lower than a threshold voltage V_{T}. The threshold voltage V_{T} is correlated to the input threshold voltage. The supply circuit 30 includes a detection terminal DET coupled to the input voltage V_{IN} through a voltage divider 40. The voltage divider 40 comprises resistors 41 and 42. The resistors 41 and 42 are coupled in series.

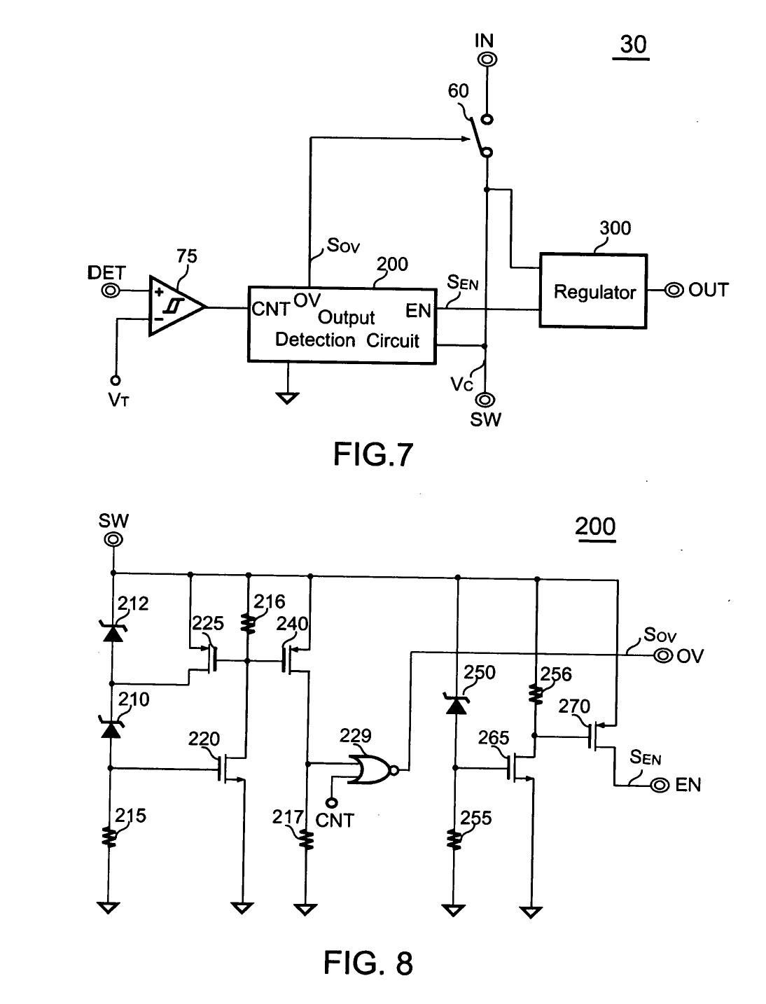

FIG. 7 shows a preferred embodiment of the supply circuit 30 of the voltage regulator shown in FIG. 5. The supply circuit 30 comprises the switch 60 coupled to the input terminal IN to receive the voltage source V_{IN} for providing the supply voltage V_{C} at the first output terminal SW. The input voltage V_{IN} is the voltage source. A positive input terminal of an input detection circuit 75 is coupled to the detection terminal DET to detect the input voltage V_{IN} via the voltage divider 40 and generate a control signal in response to the voltage level of the input voltage V_{IN}. The control signal is coupled to an input terminal CNT of an output detection circuit 200 to turn off the switch 60 when the voltage level of the input voltage V_{IN} is higher than the threshold voltage V_{T}. The input detection circuit 75 includes the threshold voltage V_{T} that is correlated to the input threshold voltage. The threshold voltage V_{T} is coupled a negative input terminal of the input detection circuit 75.

The output detection circuit 200 is coupled to the first output terminal SW to detect the supply voltage V_{C} and generate the first enable signal S_{OV} at the first enable terminal OV in response to the voltage level of the supply voltage V_{C}. The first enable signal S_{OV} is coupled to the switch 60 to switch off the switch 60 when the voltage level of the supply voltage V_{C} is higher than the output-over-voltage threshold. Besides, the output detection circuit 200 generates the second enable signal S_{EN} at the second enable terminal EN in response to the voltage level of the supply voltage V_{C}. The second enable signal S_{EN} is connected to the regulator 300 to turn off the regulator 300 when the voltage level of the supply voltage V_{C} is lower than the output-under-voltage threshold. The regulator 300 is coupled to the second output terminal OUT.

The circuit schematic of the output detection circuit 200 is shown in FIG. 8. Zener diodes 210 and 212 are connected in serial. The zener diode 212 is further connected to the first output terminal SW to detect the supply voltage V_{C}. The zener diode 210 is connected to a resistor 215. The resistor 215 is further coupled to a transistor 220. The resistor 215 is used to turn on the transistor 220 when the voltage of the supply voltage V_{C} is higher than the voltage of zener diodes 210 and 212. A transistor 225 is parallel connected with the zener diode 212 to short circuit the zener diode 212 when the transistor 220 is turned on, which achieve the hysteresis for detecting the over voltage of the supply voltage V_{C}. The zener voltage of the zener diodes 210 and 212 determines the output-over-voltage threshold. The zener voltage of the zener diode 212 determines the hysteresis threshold for the hysteresis. The first enable signal S_{OV} will switch on the switch 60 when the voltage level of the supply voltage V_{C} is lower than the hysteresis threshold.

A transistor 240 is coupled to the transistor 220 and the first output terminal SW. The transistor 240 is turned on in response to the turn-on of the transistor 220. A resistor 216 is coupled to the first output terminal SW, the transistors 225 and 240. The resistor 216 provides a bias to transistors 225 and 240. A resistor 217 is connected to the transistor 240 and an input terminal of an NOR gate 229 to control the NOR gate 229 when the transistor 220 is turned on. Another input terminal of the NOR gate 229 is connected to the input terminal CNT of the output detection circuit 200 to receive the control signal. An output terminal of the NOR gate 229 is connected to the switch 60 and generates the first enable signal S_{OV} to turn off the switch 60 once the voltage level of the supply voltage V_{C} is higher than the output-over-voltage threshold or the voltage level of the input voltage V_{IN} is higher than the threshold voltage V_{T}.

A zener diode 250 is also connected to the first output terminal SW to detect the supply voltage V_{C}. A resistor 255 is connected to the zener diode 250 and a transistor 265 to turn on the transistor 265 once the voltage level of the supply voltage V_{C} is higher than the output-under-voltage threshold. The zener voltage of the zener diode 250 determines the output-under-voltage threshold. A resistor 256 is coupled to the first output terminal SW and a transistor 270. The transistor 270 is further coupled to the first output terminal SW and the transistor 265. The transistor 270 generates the second enable signal S_{EN} when the voltage level of the supply voltage V_{C} is lower than the output-under-voltage threshold. The voltage level of the output-over-voltage threshold is higher than the hysteresis threshold. The voltage level of the hysteresis threshold is higher then the output-under-voltage threshold.

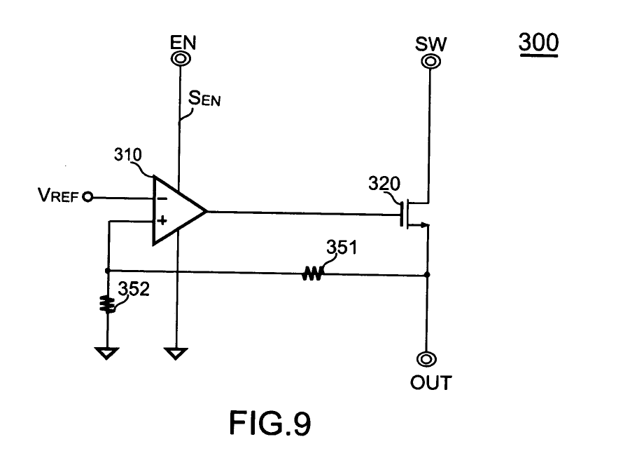

FIG. 9 shows a circuit diagram of the regulator 300 that includes an operational amplifier 310, a pass element 320 and resistors 351, 352. The operational amplifier 310 includes a reference voltage V_{REF} coupled to a negative input terminal of the operational amplifier 310. The resistor 352 is coupled to a positive input terminal of the operational amplifier 310. The second enable signal S_{EN} is coupled to the operational amplifier 310 to provide a power source to operate the operational amplifier 310. The pass element 320 is coupled to the operational amplifier 310, the first output terminal SW and the second output terminal OUT. The operational amplifier 310 and the pass element 320 are disabled once the second enable signal S_{EN} is disabled. The resistor 351 is coupled to the positive input terminal of the operational amplifier 310 and the pass element 320. The pass element 320 can be a transistor.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A voltage regulator comprising:
a switch coupled to a voltage source for providing a supply voltage;
an input detection circuit coupled to the voltage source to generate a control signal in response to the voltage level of the voltage source;
an output detection circuit coupled to the supply voltage to generate a first enable signal and a second enable signal in response to the voltage level of the supply voltage; and
a regulator coupled to the supply voltage to generate a regulated output voltage;
wherein the control signal is coupled to the switch to turn off the switch once the voltage level of the voltage source is higher than a threshold voltage, the first enable signal is further coupled to the switch to switch off the switch when the voltage level of the supply voltage is higher than an output-over-voltage threshold, the second enable signal is utilized to turn off the regulator once the voltage level of the supply voltage is lower than an output-under-voltage threshold.

2. The voltage regulator as claimed in claim 1, wherein the output detection circuit includes a hysteresis for generating the first enable signal, the first enable signal is coupled to enable the switch once the voltage level of the supply voltage is lower than a hysteresis threshold, in which the output-over-voltage threshold is higher than the hysteresis threshold, and the hysteresis threshold is higher than the output-under-voltage threshold.

3. The voltage regulator as claimed in claim 1, wherein the voltage source is coupled to an AC power source through a plurality of rectifiers.

4. The voltage regulator as claimed in claim 1, wherein the input detection circuit is coupled to the voltage source through a voltage divider.

5. A voltage regulation circuit comprising:
a switch coupled to a voltage source for providing a supply voltage; and
an output detection circuit coupled to the supply voltage to generate a first enable signal in response to the voltage level of the supply voltage;
wherein the first enable signal is coupled to the switch to turn off the switch when the voltage level of the supply voltage is higher than an output-over-voltage threshold.

6. The voltage regulation circuit as claimed in claim 5, wherein the first enable signal is utilized to turn on the switch once the voltage level of the supply voltage is lower than a hysteresis threshold, in which the output-over-voltage threshold is higher than the hysteresis threshold.

7. The voltage regulation circuit as claimed in claim 5, further comprises a regulator coupled to the supply voltage to generate a regulated output voltage.

8. The voltage regulation circuit as claimed in claim 7, wherein the output detection circuit further generates a second enable signal to disable the regulator when the voltage level of the supply voltage is lower than an output-under-voltage threshold.

9. The voltage regulation circuit as claimed in claim 5, wherein the voltage source is coupled to an AC power source through a plurality of rectifiers.

10. The voltage regulation circuit as claimed in claim 5, further comprises an input detection circuit coupled to the voltage source to turn off the switch once the voltage level of the voltage source is higher than a threshold voltage.

11. The voltage regulation circuit as claimed in claim 10, wherein the input detection circuit is coupled to the voltage source through a voltage divider.

12. A power supply circuit comprising:
a switch coupled to a voltage source for providing a supply voltage; and
an input detection circuit coupled to the voltage source to turn on the switch once the voltage level of the voltage source is lower than a threshold voltage.

13. The power supply circuit as claimed in claim 12, further comprises a regulator coupled to the supply voltage to generate a regulated output voltage.

14. The power supply circuit as claimed in claim 12, wherein the voltage source is coupled to an AC power source through a plurality of rectifiers.

15. The power supply circuit as claimed in claim 12, wherein the input detection circuit generates a control signal in response to the voltage level of the voltage source, the control signal is coupled to the switch to turn on the switch once the voltage level of the voltage source is lower than the threshold voltage.

16. The power supply circuit as claimed in claim 12, wherein the input detection circuit is coupled to the voltage source through a voltage divider.

17. The power supply circuit as claimed in claim 12, further comprises an output detection circuit coupled to the supply voltage to turn off the switch when the voltage level of the supply voltage is higher than an output-over-voltage threshold.

18. A voltage regulator comprising:
a switch providing a supply voltage in response to a voltage source;
an input detection circuit generating a control signal in response to the voltage level of the voltage source;
an output detection circuit generating a first enable signal and a second enable signal in response to the voltage level of the supply voltage; and
a regulator generating a regulated output voltage in response to the supply voltage;
wherein the control signal turns off the switch once the voltage level of the voltage source is higher than a threshold voltage, the first enable signal switches off the switch when the voltage level of the supply voltage is higher than an output-over-voltage threshold, the second enable signal turns off the regulator once the voltage level of the supply voltage is lower than an output-under-voltage threshold.

19. The voltage regulator as claimed in claim 18, wherein the output detection circuit includes a hysteresis for generating the first enable signal, the first enable signal is coupled to enable the switch once the voltage level of the supply voltage is lower than a hysteresis threshold, in which the output-over-voltage threshold is higher than the hysteresis threshold, and the hysteresis threshold is higher than the output-under-voltage threshold.

20. A voltage regulation circuit comprising:
a switch providing a supply voltage in response to a voltage source; and
an output detection circuit generating an first enable signal in response to the voltage level of the supply voltage;
wherein the first enable signal turns off the switch when the voltage level of the supply voltage is higher than an output-over-voltage threshold.

21. The voltage regulation circuit as claimed in claim 20, wherein the first enable signal is utilized to turn on the switch once the voltage level of the supply voltage is lower than a hysteresis threshold, in which the output-over-voltage threshold is higher than the hysteresis threshold.

22. A power supply circuit comprising:
a switch providing a supply voltage in response to a voltage source; and
an input detection circuit turning on the switch once the voltage level of the voltage source is lower than a threshold voltage.

23. The power supply circuit as claimed in claim 22, wherein the input detection circuit generates a control signal in response to the voltage level of the voltage source, the control signal is coupled to the switch to turn on the switch once the voltage level of the voltage source is lower than the threshold voltage.
